(19) United States
(12) Patent Application Publication
(10) Pub. No.: US 2017/0216858 A1
(43) Pub. Date: Aug. 3, 2017

(54) OUTDOOR PAINT SPRAYER

(71) Applicant: CRAYOLA, LLC, Easton, PA (US)

(72) Inventors: JOHN D. McBRIDE, JR., EASTON, PA (US); THOMAS R. RAU, EASTON, PA (US); CHRISTOPHER P. OREM, EASTON, PA (US)

(21) Appl. No.: 15/418,289

(22) Filed: Jan. 27, 2017

Related U.S. Application Data
(60) Provisional application No. 62/288,423, filed on Jan. 28, 2016.

(51) Int. Cl. B05B 7/04; B05B 11/00

(52) U.S. Cl. CPC B05B 7/04; B05B 11/3001; B05B 11/0037

(57) ABSTRACT

Embodiments of the invention are directed to an outdoor paint sprayer having an air pump chamber separate from a refillable and/or replaceable paint chamber. In some aspects, the outdoor paint sprayer is configured to dispense a liquid paint with minimal dilution, such that a paint having an original concentration may be aspirated and dispersed by the outdoor paint sprayer without requiring additional manipulation of the paint outside of the sprayer. In some aspects, the outdoor paint sprayer includes one or more nozzle features and/or tips that produce a desired spraying application. In further aspects, additional features for emulating a particular marking effect may be incorporated with and/or coupled to the sprayer for application.

### CROSS-REFERENCE TO RELATED APPLICATIONS

This application claims priority to U.S. Provisional Patent Application No. 62/288,423, entitled “Outdoor Paint Sprayer,” filed Jan. 28, 2016, the entire contents of which is hereby incorporated by reference.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section below. This summary is not intended to identify key features or essential features of the claimed subject matter, nor is it intended to be used as an aid in isolation to determine the scope of the claimed subject matter.

In brief and at a high level, this disclosure describes, among other things, an outdoor paint sprayer having an air pump chamber separate from a paint chamber. In some aspects, the air pressure created by the air pump chamber is transferred to the paint chamber prior to dispensing the atomized paint product from a nozzle feature of the outdoor paint sprayer. Additionally, one or more of the air pump chamber, the paint chamber, and the nozzle of the outdoor paint sprayer may be configured to dispense a liquid paint product having a particular viscosity within a particular range. In some aspects, the nozzle feature of the outdoor paint sprayer may be configured to dispense separated, uniformly distributed, and/or atomized liquid paint in a particular dispersion pattern and/or with a particular desired application. For example, the particular pattern and/or desired application may include a particular spray pattern for contacting a surface within a threshold distance from the outdoor paint sprayer, a specific spray tip for marking on a surface to provide a particular visual effect, a desired spray range for covering a particular surface at a particular rate, an adjusted spray force for a particular paint viscosity, and/or a desired efficiency for paint transfer with minimal clogging of one or more dispensing mechanisms.

### DESCRIPTION OF THE DRAWINGS

Illustrative embodiments of the invention are described in detail below with reference to the attached drawing figures, and wherein:

FIG. 1 is a side, perspective view of an outdoor paint sprayer device having an air pump chamber separate from a paint compartment, in accordance with an embodiment of the invention;

FIG. 2 is a cross-sectional view of an exemplary outdoor paint sprayer device with a series of valves and hoses between the air pump chamber, the paint compartment, the sprayer body, and the nozzle, in accordance with an embodiment of the invention;

FIG. 2A is an enlarged cross-sectional view of an exemplary one-way valve assembly, in accordance with an embodiment of the invention;

FIG. 3 is a cross-sectional view of a portion of an exemplary outdoor paint sprayer valve assembly, in accordance with an embodiment of the invention;

FIG. 4 is a cross-sectional view of a portion of an exemplary outdoor paint sprayer pressure relief valve assembly, in accordance with an embodiment of the invention;

FIG. 5A is an enlarged, cross-sectional portion of an exemplary outdoor paint sprayer in an inactive state, in accordance with an embodiment of the invention;

FIG. 5B is an enlarged, cross-sectional portion of exemplary outdoor paint sprayer in a activated state, in accordance with an embodiment of the invention;

FIG. 6 is an enlarged, cross-sectional portion of an exemplary nozzle assembly, in accordance with an embodiment of the invention;

FIG. 7 is an enlarged, cross-sectional portion of an exemplary nozzle assembly and sample spray pattern, in accordance with an embodiment of the invention;

FIG. 8A is an exemplary outdoor paint sprayer depicted in a pressurized state ready for use, in accordance with an embodiment of the invention;

FIG. 8B is an exemplary outdoor paint sprayer depicted in a pressurized state ready for use with the nozzle assembly disassembled, in accordance with an embodiment of the invention;

FIG. 9 is a partially exploded view of an exemplary outdoor paint sprayer, in accordance with an embodiment of the invention;

FIG. 10 is an exemplary dispersion nozzle with a plurality of orifices for an outdoor paint sprayer, in accordance with an embodiment of the invention;

FIG. 11 is an exemplary operating environment and exemplary outdoor sprayer kit, in accordance with an embodiment of the invention; and

FIG. 12 is an exemplary outdoor sprayer kit, in accordance with an embodiment of the invention.

### DETAILED DESCRIPTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Embodiments of the invention include, among other things, an outdoor paint sprayer having an air pump chamber separate from a paint chamber. In some aspects, the air pressure created by the air pump chamber is transferred to the paint chamber prior to dispensing the atomized paint product from a nozzle feature of the outdoor paint sprayer. Additionally, one or more of the air pump chamber, the paint chamber, and the nozzle of the outdoor paint sprayer may be configured to dispense a liquid paint product having a particular viscosity within a particular range. In some aspects, the nozzle feature of the outdoor paint sprayer may be configured to dispense separated, uniformly distributed, and/or atomized, liquid paint in a particular dispersion pattern and/or with a particular desired application. For example, the particular pattern and/or desired application may include a particular spray pattern for contacting a particular surface within a threshold distance from the outdoor paint sprayer, a specific spray tip for marking on a surface to provide a particular visual effect, a desired spray range for covering a particular surface at a particular rate, an adjusted spray force for a particular paint viscosity, and/or a desired efficiency for paint transfer with minimal clogging of one or more dispensing mechanisms. Accordingly, aspects of the invention provide a liquid paint dispensing device having a first chamber for generating an amount of hand-pumped air pressure, a second chamber for enclosing an amount of liquid paint (i.e., liquid paint having a variety of viscosities and/or fluid characteristics) and receiving the generated air pressure, and a common housing proximate the first and second chamber that variably facilitates release of the pressurized paint via a triggering mechanism and dispenses the liquid paint in an outward direction via an optimized nozzle.

In one embodiment, an outdoor paint sprayer device comprises: a sprayer body; a paint chamber coupled to the sprayer body at a first position; an air pump chamber coupled to the sprayer body at a second position different than the first position; a nozzle feature coupled to the sprayer body; a trigger mechanism for providing an indication to dispense paint from the paint chamber; an air hose structure coupled between the air pump chamber and the paint chamber; and a paint hose structure coupled between the paint chamber and the nozzle, wherein the air pump chamber comprises at least a first valve assembly, and the paint chamber comprises at least a second valve assembly.

In another embodiment, a paint spraying device comprises: a sprayer body comprising at least one nozzle feature and at least one valve assembly; an air pump chamber coupled to the sprayer body, said air pump chamber comprising a pressure relief valve assembly, a pump mechanism, and a pump chamber port; and a paint chamber coupled to the sprayer body, said paint chamber comprising a one-way air valve, wherein the paint chamber is separate from the air pump chamber.

In a further embodiment, a device for dispensing an undiluted liquid paint comprises: an air pump chamber comprising a pressure relief valve assembly; a paint chamber separate from the air pump chamber and coupled to the air pump chamber via an air hose and a one-way air valve; and a nozzle comprising a valve assembly and a trigger mechanism, said nozzle coupled to said paint chamber via a paint hose.

One or more features of the outdoor paint sprayer may be optimized for dispersing a paint solution having a particular viscosity, with a particular spray characteristic and/or pattern, such as the exemplary spray pattern and nozzle feature in one example. In one aspect of the invention, the outdoor paint sprayer may include a separate air pump chamber and separate, refillable paint chamber that is configured to disperse a paint solution having between about 50 to 100% viscosity, in a range between a partially diluted or undiluted state from an original concentration. In further embodiments, the outdoor paint sprayer may be configured to disperse a paint solution having between about 70 to 100% viscosity, while in further aspects, a paint solution between 80 and 100% viscosity may be dispensed from the outdoor paint sprayer in a consistent spray pattern. In further aspects, an embodiment of the outdoor paint sprayer is configured to disperse a liquid paint having about 95% viscosity.

As such, a method for use of the outdoor paint sprayer may include loading paint into the paint chamber, hand-pumping air into the air pump chamber, and actuating a trigger to apply the liquid paint to an outdoor surface. In some aspects, the hand-pumped air supply pressurizes the paint chamber proximate a first end of the paint chamber, and upon actuating by a trigger, the liquid paint is released proximate a second end opposite the first end, through a nozzle and onto an outdoor surface. In further aspects, the paint chamber may be refillable by a user, such that at least a portion of the paint chamber is removably coupled, providing access to an interior portion of the paint chamber. In other aspects, additional, pre-loaded paint chambers, such as one or more refill canisters of liquid paint, may be configured to couple to the sprayer base/body, providing a single spray gun for dispensing multiple, interchangeable colors. Further, one or more stencil and refill components may be provided for an outdoor paint sprayer, in accordance with an embodiment of the invention.

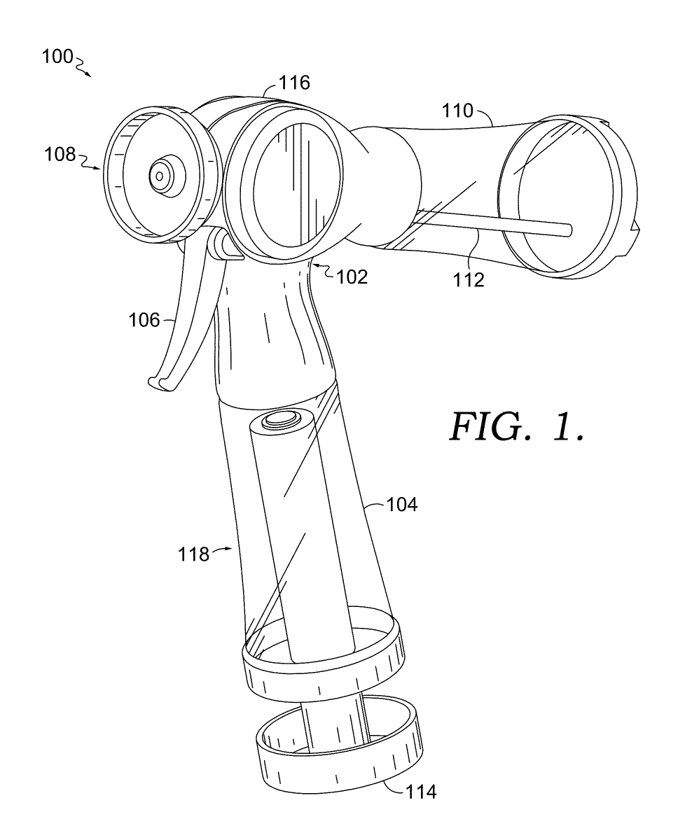

With reference now to the figures, FIG. 1 is a side, perspective view of an outdoor paint sprayer device 100 having an air pump chamber 104 separate from a paint chamber 110, in accordance with one embodiment of the invention. In this embodiment, the outdoor paint sprayer may include a sprayer body 102 coupled to a nozzle assembly 108, a refillable paint chamber 110, an air pump chamber 104 having an air pump mechanism 118, and a trigger 106. In embodiments, a tip harness 116 may be affixed to the sprayer body 102 at a first end of the tip harness 116 and affixed to a removable spray tip 504 of the nozzle assembly 108 at a second end of the tip harness. In such an embodiment, the tip harness 116 allows a user to remove the spray tip 504 from the nozzle assembly 108 for cleaning without the risk of misplacing the spray tip. Additionally, or alternatively, the tip harness 116 may allow a user to remove the spray tip 504 and dispense the liquid paint product directly from the dispersion nozzle without the risk of misplacing the spray tip 504.

In embodiments, the tip harness 116 may be removably affixed to the spray tip 504, such that the spray tip 504 may be replaced by a similar spray tip 504 or an alternative spray tip 504 having the same or different throughput features, such as a differently shaped opening. For example, if a first spray tip 504 is damaged, the user may remove the spray tip 504 from the nozzle assembly 108, remove the tip harness 116, replace the damaged spray tip 504 with a different spray tip 504, and attach the tip harness 116 to the undamaged spray tip 504. Additionally, or alternatively, aspects of the invention provide a removable first spray tip 504 that may be exchanged with a second spray tip 504 that produces a different liquid paint product spray profile. For example, the first spray tip 504 may be configured to spray liquid paint product in a circular pattern, a second spray tip 504 may be configured to spray liquid paint product in a half circle pattern, and a third spray tip 504 may be configured to spray liquid paint product in a crescent moon pattern. It will be understood by those skilled in the art that many different spray profiles and/or patterns may be created utilizing one or more spray tips 504, and remain within the scope of the present invention.

In some embodiments, the tip harness 116 may be at least partially flexible so as to facilitate easy cleaning and/or spray tip exchange while maintaining structural integrity. In some aspects, the tip harness 116 may be affixed to the spray body 102 and/or the spray tip 504 in many different configurations. In further aspects, the nozzle assembly 108 may include a spray tip 504 that is not removable, separate or continuous with surrounding nozzle features.

With continued reference to FIG. 1, the paint chamber 110 provides a liquid paint product reservoir, with an internal chamber configured to supply liquid paint product to be dispensed through the nozzle assembly 108. In embodiments, the paint chamber 110 may be coupled to the sprayer body 102 at a first position. In such an embodiment, the paint chamber 110 may comprise a refill chamber port 204, a refill chamber gasket (not shown), and a refill reservoir 206. This configuration may allow the paint chamber 110 to be, at least temporarily, uncoupled from the sprayer body 102 so that the paint chamber 110 can be cleaned, refilled with similar, liquid paint product, or refilled with a different liquid paint product (e.g., a liquid paint product of a different color). The paint chamber 110 may then be re-coupled to the sprayer body 102 at the refill chamber port 204 without damaging the outdoor paint sprayer or the sprayer body 102. In other words, while the outdoor paint sprayer or sprayer body 102 remains intact, the removable paint chamber 110 may be accessed at one or more portions of the device, such as a rotatably coupled opening proximate an attachment point between the paint chamber 110 and the sprayer body 102. Additionally, or alternatively, the paint chamber 110 may further comprise a refill chamber end cap, such as a removably coupled end cap opposite the attachment end of the paint chamber that is directly coupled to the sprayer body 102. In an embodiment, the refill chamber end cap may be removably coupled to the paint chamber to achieve similar functionality as discussed above.

In embodiments, the trigger mechanism 106 provides an indication to the outdoor paint sprayer to dispense liquid paint product through the nozzle assembly 108. In embodiments, the trigger mechanism 106 is connected with a valve assembly such that activating the trigger mechanism 106 mechanically opens the valve assembly allowing liquid paint product to be dispensed through the nozzle assembly 108. In alternative embodiments, the trigger mechanism 106 may provide an electrical indication that actuates the valve assembly allowing liquid paint product to be dispensed through the nozzle assembly.

In the depicted embodiment of the outdoor paint sprayer device 100, the air pump chamber 104 is coupled to the sprayer body 102 at a second position. For example, the paint chamber 110 may be coupled to the sprayer body 102 at a first position generally parallel to the direction of paint flow exiting the sprayer device 100, while the air pump chamber 104 may be coupled to the sprayer body 102 at a second position that bisects the generally parallel axis of the paint chamber 110. Aspects of the air pump chamber 104 comprise a manual air pump mechanism 118 positioned in an internal cavity of the air pump chamber 104, wherein the pump mechanism 118 further comprises a pump handle 114. Further embodiments of the air pump mechanism 118 comprise a one-way air valve configured so that air is pumped into the air chamber 104 when the user operates the pump mechanism 118. In embodiments, the one-way air valve includes one or more features of an umbrella valve that seals the air pump mechanism 118 while the pump handle 114 is drawn back and opens the air pump mechanism 118 while the pump handle 114 is driven up such that air is delivered into the air chamber 104. In some embodiments, the pump mechanism 118 may further comprise a pressure release valve 214. In such an embodiment the pressure release valve 214 may insure that the air pressure created by the air pump mechanism 118 does not exceed a threshold pressure.

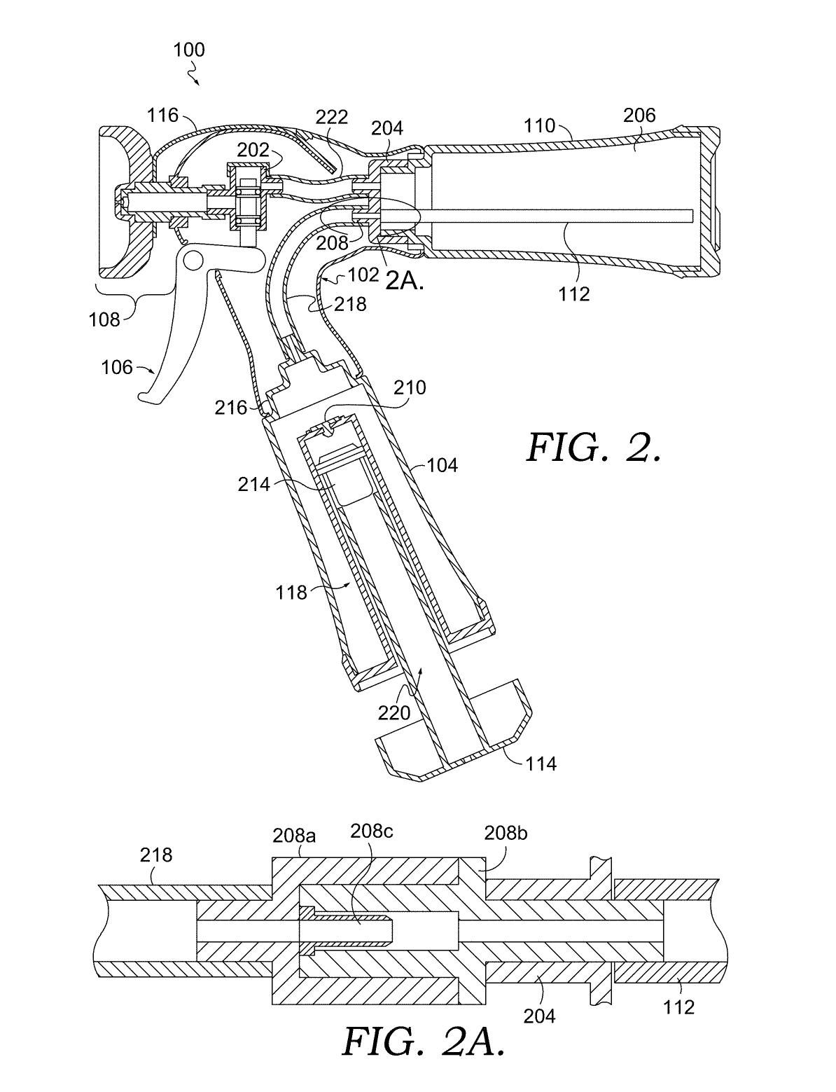

Turning next to FIG. 2, a cross-sectional view of the exemplary outdoor paint sprayer device 100 is shown in accordance with an embodiment of the invention. The outdoor sprayer device 100 may include the nozzle assembly 108 and the sprayer body 102 arranged along a central x-axis. As discussed later, in embodiments, components of the nozzle assembly 108 may be coupled to the sprayer body 102 at a first location on the sprayer body 102. In further embodiments, the sprayer body 102 may have a plurality of coupling locations for the coupling of at least one other component. For example, the outdoor paint sprayer 100 may comprise the sprayer body 102, the nozzle assembly 108 coupled at the first position of the sprayer body 102, the air pump chamber 104 coupled at a second position (pump chamber port 216) of the sprayer body 102, the paint chamber 110 coupled at a third position (paint chamber port 204) of the sprayer body 102, the trigger mechanism 106 movably coupled to a fourth position of the sprayer body 102, and the tip harness 116 coupled to a fifth position of the sprayer body 102. As such, air pumped in the air pump chamber 104 by the pump mechanism 118 may be transferred to the paint chamber 110, and used to dispense paint from the paint chamber 110, through a valve assembly 202, and exit a nozzle assembly 108. Such nozzle assembly 108 may include one or more valves and/or tip structures configured to disperse the paint from the paint chamber, such as with a desired force and/or spray pattern.

In embodiments, the air pump chamber 104 further comprises an air hose 218, a one-way air valve 210, an air chamber 212, a pump mechanism 118, a pump handle 114, and a pressure relief valve 214. In an embodiment, the one-way air valve 210 is an umbrella valve configured such that air being pumped by the pump mechanism 118 can enter the air chamber 212 but not exit the air chamber 212 through the pump mechanism 118. Those skilled in the art will understand that many different valve assemblies, for example one-way air valves, may perform this function consistent with the present invention.

In an embodiment, the pressure release valve 214 may be configured such that the air pressure within the air pump chamber may not exceed a predetermined threshold pressure. In embodiments, the pressure release valve 214 is coupled with a pressure release vent 220, the pressure release vent comprising a hollow cavity within the pump mechanism 118 running longitudinally from the pressure release valve 214 to the surface of the pump handle 114. In such an embodiment, the addition of any air to the air chamber 212 that exceeds the threshold air pressure may activate the pressure relief valve 214, allowing the excess air pressure to be released through the pressure release vent 220 and back into the environment outside the pump handle 114. In embodiments, once the air pressure in the air chamber 212 falls below the threshold pressure, the pressure relief valve 214 automatically closes, preventing the further loss of air pressure. As such, application of pressure to the air chamber 212 via pumping action of the pump mechanism 118 may be automatically regulated to prevent over-pumping by a user, and in turn, maintain the stability of one or more components within the outdoor paint spray device 100. In further aspects, a consistent spray pattern of atomized liquid paint may be dispensed with a threshold amount of force transferred from the air-pressurized pump mechanism 118.

As depicted in FIG. 2, in one embodiment, the pump mechanism 118 may be a hand operated air pump. The pump mechanism 118 may be operated by pulling on the pump handle 114 that draws air into the pump mechanism 118. In further aspects, the pump mechanism 118 may be operated by pushing on the pump handle 114, which pushes air toward the one-way valve 210. The air may then open the one-way valve 210 and permit air to flow into the air chamber 212. In embodiments, this process may be repeated as many times as desired, incrementally increasing the air pressure until the desired air pressure is reached. In further embodiments, this process may repeated as many times as desired until the air pressure in the air chamber 212 reaches a threshold pressure that activates the pressure release valve 214. In alternative embodiments, the pump mechanism 118 may be any air pump mechanism known or developed in the future, such as a pneumatic air pump, an electric air pump, a compressed air cartridge system, or the like.

Embodiments of the air pump chamber 104 may be coupled to the sprayer body at an air pump chamber port 216. In one embodiment, the coupling between the sprayer body 102 and the air pump chamber port 216 may be any coupling known in the art or developed in the future that provides an airtight coupling between the sprayer body 102 and the air pump chamber port 216. For example, coupling between the sprayer body 102 and the air pump chamber port 216 may be permanent, or semi-permanent, joining the sprayer body 102 and the air bump chamber port 216 in an airtight configuration. In alternative embodiments, the air pump chamber 104 may be removably coupled with the sprayer body 102 at the air pump chamber port 216.

Aspects of the air pump chamber 104 may comprise an air hose 218. The air hose 218 may be coupled to the air pump chamber 104 at a first end of the air hose 218 and the paint chamber 110 at a second end of the air hose 218 so that air pumped into the air pump chamber 104 flows through the air hose 218 into the paint chamber 110. In an embodiment, the air hose 218 may be coupled to a one-way valve 208 that is incorporated into the paint chamber port 204. In such an embodiment, the one-way valve 208 is configured to allow air to flow from the air pump chamber 104, through the air hose 218, and into the paint chamber 110 while the one-way valve 208 prevents any retrograde flow from the paint chamber 110 to the air pump chamber 104. In embodiments, the one-way valve 208 comprises a duckbill valve. However, it will be understood by those skilled in the art that any valve structure, such as a one-way valve that provides unidirectional flow and an air-tight seal, may be incorporated in an embodiment without departing from the scope of the disclosed invention. In further embodiments, the air hose 218 passes through a hollow interior portion of the sprayer body 102 from the air pump chamber 104 to the paint chamber 110, such that the air hose 218 may be enclosed by the sprayer body 102.

Continuing with FIG. 2, embodiments of the paint chamber 110 further comprise a proximal first end configured for coupling to the sprayer body 102 at the paint chamber port 204, a distal second end of the paint chamber 110, and a hollow refill reservoir 206 for holding an amount of liquid paint product. In embodiments, the paint chamber further comprises a one-way valve 208, as discussed above. In embodiments, the one-way valve 208 may allow the unidirectional flow of air from the air pump chamber 104 to the paint chamber 110. In additional embodiments, the paint chamber further comprises a second air hose 112 that is coupled to the one-way valve 208 opposite the first air hose 218. The second air hose 112 may be coupled to the one-way valve 208 at a first end of the second air hose 112 and configured such that the air exits the air hose 218 at the second end of the second air hose 112 proximate the distal second end of the paint chamber 110. As such, air exiting the air hose 218 may form, at least partially, an air pocket proximate the distal second end of the paint chamber 110. In such an embodiment, for example, the inadvertent combination of pressurized air and liquid paint is reduced, and creation of foam is minimized, such as foam formed between an amount of air and at least a portion of the liquid paint product. In one embodiment, the first air hose 218 and the second air hose 112 may comprise a unified air hose with the one-way valve integrated into the unified air hose. Accordingly, although depicted as separate hose features, it will be understood that multiple hose components may be combined into a single or multiple units. In an alternative embodiment, the second air hose 112 may be integrated into an inner surface of the paint chamber 110 such that the second air hose 112 is formed from a hollow cavity structure integrated into the paint chamber running from the proximal first end to the distal second end of the paint chamber 110. That is, a non-removable air hose may be integrated into the paint chamber 110 to provide air access to the distal second end of the paint chamber 110 (i.e., “behind” the paint being dispensed).

Embodiments of the paint chamber 110 further comprise a paint hose feature for providing paint to the nozzle assembly 108. In an embodiment, the paint hose feature may include a first paint hose 222 having a first end coupled to the paint chamber 110 and a second end coupled to the sprayer valve assembly 202. As such, paint flowing through the paint hose 222 may flow from the paint chamber 110 to the valve assembly 202 and flow from the valve assembly 202 to the nozzle assembly 108. In embodiments, activating the trigger mechanism 106 may selectively open the valve assembly 202 and may allow the flow of liquid paint from the paint chamber 110, through the valve assembly 202, and on to the nozzle assembly 108. In some embodiments, the paint hose feature includes a second paint hose (not depicted) coupled to the sprayer valve assembly 202 at a first end and coupled to the nozzle assembly 108 at a second end. In alternative embodiments, the nozzle assembly 108 may be coupled directly to the valve assembly 202. It will be understood by those skilled in the art that the many configurations of the paint hose feature and the sprayer valve assembly 202 are possible within the scope of the disclosed invention.

Turning now to FIG. 2A, an enlarged cross-sectional view of an exemplary embodiment of the one-way valve 208 is provided. In embodiments, the one-way valve 208 may comprise an assembly of components. For example, in embodiments, the one-way valve 208 may comprise a valve collar 208a, a valve sleeve 208b, and a duckbill seal 208c. As depicted in FIG. 2A, in embodiments, air hose 218 may be coupled to a first side of valve collar 208a; a second side of valve collar 208a may be coupled to a first side of valve sleeve 208b, with duckbill seal 208c nested between the coupling of valve collar 208a and valve sleeve 208b; a second side of valve sleeve 208b may be coupled with refill chamber port 204, such that, at least, a portion of the second side of valve sleeve 208b extends through refill chamber port 204; and, the portion of the second side of valve sleeve 208b may be coupled to second air hose 112. As such, air may flow through air hose 218, valve collar 208a, duckbill seal 208c, valve sleeve 208b, second air hose 112 and exit second air hose 112 proximate the distal second end of the paint chamber 110. In embodiments, the duckbill seal 208c is configured to allow air to flow from the valve collar 208a into the valve sleeve 208c while preventing any retrograde flow from valve sleeve 208c to valve collar 208a. It will be understood by those skilled in the art that the many configurations of the components discussed immediately above may be incorporated in an embodiment without departing from the scope of the disclosed invention.

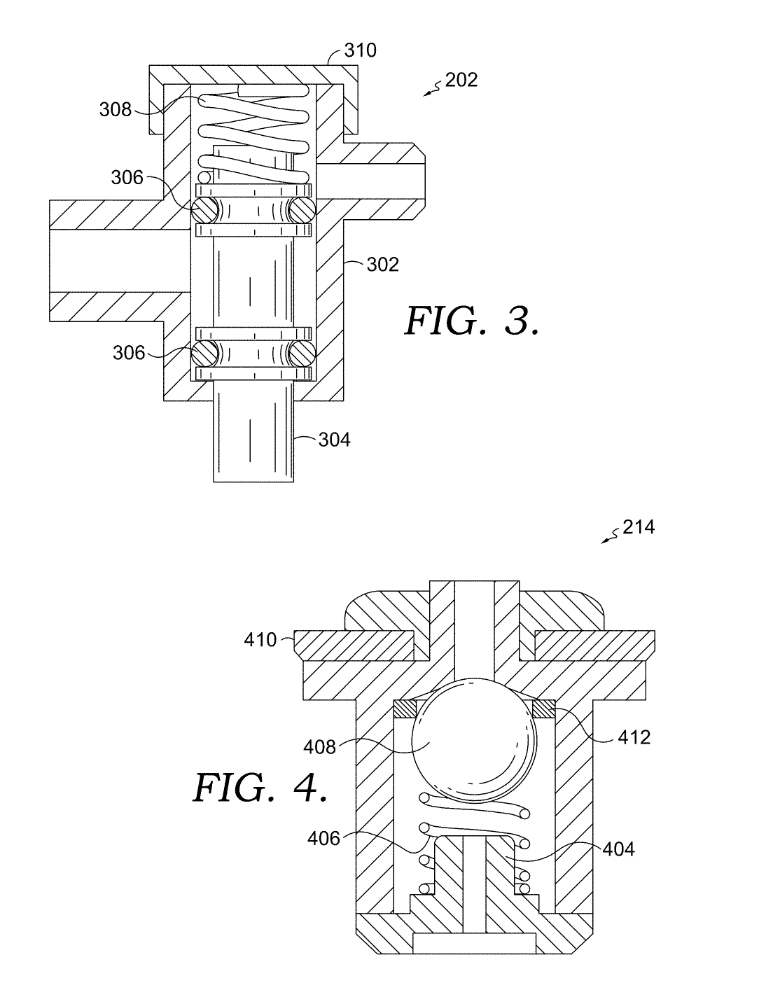

Turning now to FIG. 3, a cross-sectional view of an exemplary outdoor paint sprayer valve assembly 202 is provided. As depicted, embodiments of the sprayer valve assembly 202 comprise a valve body 302, a valve pin 304, at least one valve O-ring 306 to prevent unwanted spraying and leakage of the liquid paint product, a valve spring 308, and a valve body cap 310. In further embodiments, activation of the trigger mechanism 106 applies a mechanical force on the valve pin 304, such that the valve pin 304 may move, at least partially, vertically within the valve body 302, wherein the movement of the valve pin 304 compresses, at least partially, the valve spring 308. As the exemplary depiction suggests, translational and/or vertical movement of the valve pin 304 may result in the opening, at least partially, of the valve restricting paint flow, such that paint is then permitted to flow from the paint chamber 110 through the sprayer valve assembly 202 and to the nozzle assembly 108. However, it will be understood by those skilled in the art that any valve structure may be incorporated in an embodiment without departing from the scope of the disclosed invention, while providing a mechanism to selectively control flow of paint from one portion of the sprayer valve assembly 202 to another.

With reference to FIG. 4, a cross-sectional view of an exemplary outdoor paint sprayer pressure relief valve assembly 214 includes one or more features configured to facilitate valve function during pumping of the air chamber, such as one or more features for generating a desired amount of pressure to transfer into the paint chamber, and disperse the paint from the outdoor paint sprayer. In an embodiment, the pressure relief valve assembly 214 further comprises a pressure relief valve body 402, a pressure relief valve cap 404, a pressure relief valve spring 406, a pressure relief valve ball 408, a pump gasket 410, and a pressure relief valve seal 412. The force of the air pressure pushes against the pressure relief valve ball 408, the pressure relief valve ball 408 may, at least partially, compress the pressure relief valve spring 406, and air may be allowed to flow around the pressure relief valve ball 408 through an opening in the pressure relief valve cap 404 to the pressure relief vent and back into the environment. In such an embodiment, the attempted addition of air that results in an air pressure over the threshold pressure may activate the pressure release valve 214, preventing the over-pressurization of the outdoor paint sprayer. However, it will be understood by those skilled in the art that any pressure release valve structure may be incorporated in an embodiment without departing from the scope of the disclosed invention. In some aspects, air released into the environment refers to air not retained within the outdoor paint sprayer, permitted to flow to the exterior of the sprayer body and/or pumping chamber.

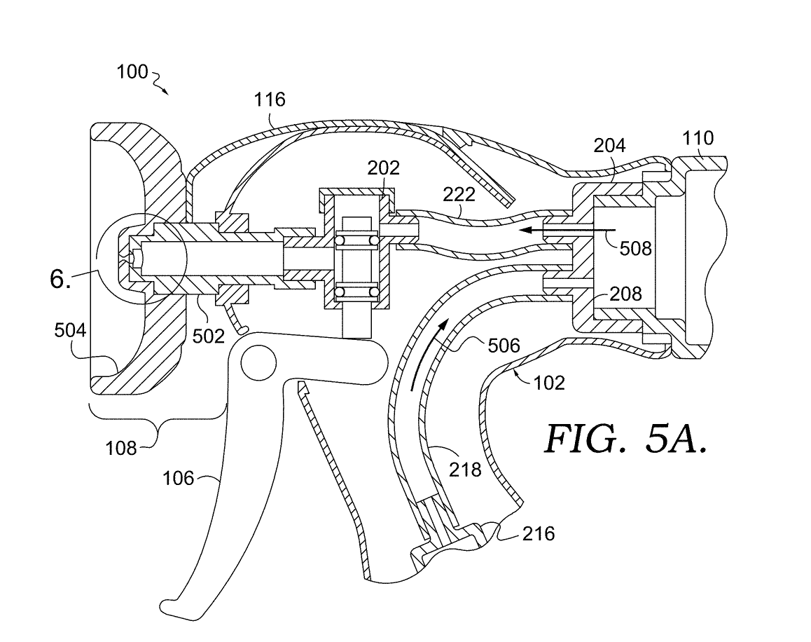

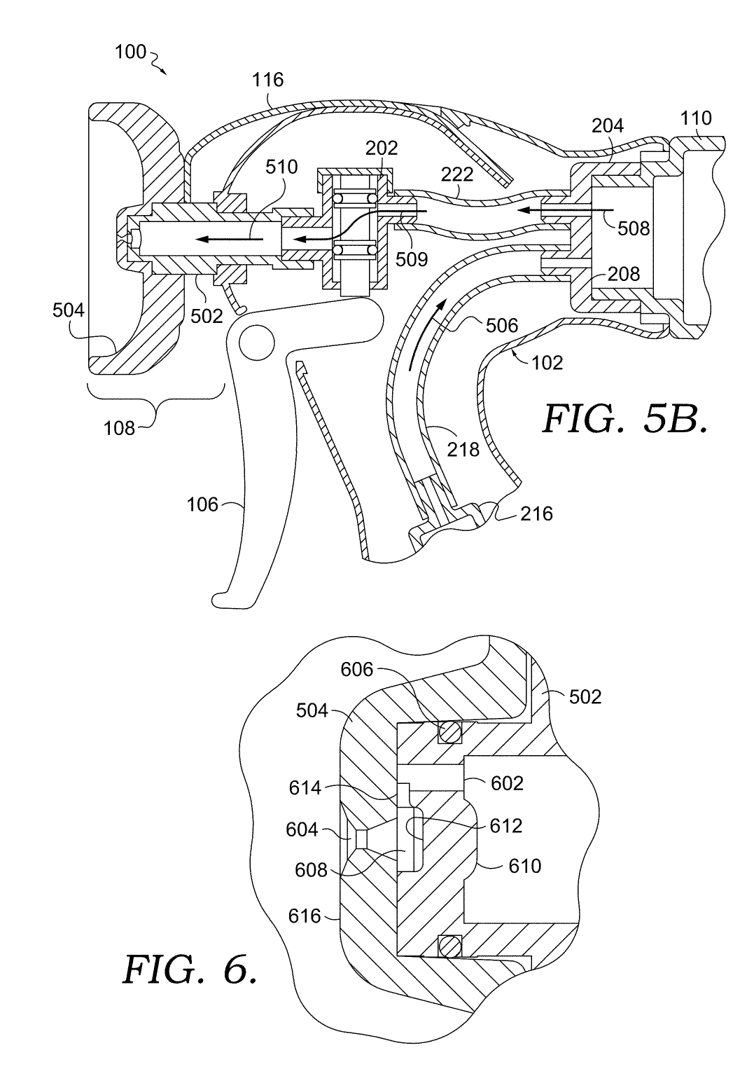

Turning to FIG. 5A, an enlarged cross-sectional portion of an exemplary nozzle assembly 108 comprises a dispersion nozzle 502 coupled to the sprayer body 102 and a spray tip 504. In further embodiments, the spray tip 504 is removably coupled to the dispersion nozzle 502.

Further, FIG. 5A provides an exemplary illustration of a possible use case in an inactive state. As one example, air from the air pump chamber 104 flows through the air hose 218 into the paint chamber 110, as illustrated by the air flow arrow 506. As air flows in accordance to air flow arrow 506, pressure builds within the paint chamber 110 and a portion of liquid paint product may be forced into the paint hose 222 toward the sprayer valve assembly 202, as illustrated by the first paint flow arrow 508. When the trigger mechanism 106 is not activated sprayer valve assembly 202 is in a closed position, such that liquid paint product may not pass through the sprayer valve assembly. It will be understood by those in the art that this is merely one example of many possible component configurations and flow configuration within the scope of the claimed invention.

FIG. 5B provides an exemplary illustration of a possible use case in an active state. Activation of the trigger mechanism 106 may open the sprayer valve assembly 202. In embodiments, a portion of liquid paint product may then flow through the open sprayer valve assembly 202, as indicated by the second paint flow arrow 509. This may allow the release of a spray of liquid paint product out the nozzle assembly 108, as indicated by the second paint flow arrow 510. However, it will be understood by those in the art that this is merely one example of many possible component configurations and flow configuration within the scope of the claimed invention.

Turning to FIG. 6, an enlarged cross-sectional portion of an exemplary nozzle assembly 108 depicts a dispersion nozzle 502 comprising a plurality of dispersion nozzle orifices 602, a spray tip 504 comprising at least one spray tip orifice 604, and a dispersion nozzle gasket 606. In some aspects, the dispersion nozzle 502 includes an inner surface 610 and an outer surface 612, the spray tip 504 having an inner surface 614 and an outer surface 616. In an embodiment, the nozzle assembly 108 further comprises a vortex chamber 608 created from a hollow cavity between the outer surface of the dispersion nozzle 612 and the inner surface of the spray tip 614. The vortex chamber 608 may be configured to cause, at least, a portion of a liquid paint product entering the vortex chamber 608 from the plurality of dispersion orifices 602 to create, at least partially, a vortex which may, at least partially, atomize a portion of the liquid paint product in the vortex chamber 608. Further, in embodiments, the at least one spray tip orifice 604 may be at least partially be aligned with the vortex chamber along a central x-axis. It will be understood by those skilled in the art that while only one of the plurality of dispersion nozzle orifices 602 is show in FIG. 6, further aspects of the nozzle orifices 602 in embodiments of a three-dimensional device are within the scope of the disclosed invention.

In embodiments, the dispersion nozzle gasket 606 is, at least, partially recessed in the dispersion nozzle 502 such that when the spray tip 504 is removably coupled, a seal is formed between the spray tip 504, the dispersion nozzle gasket 606, and the dispersion nozzle 502. As such, the liquid paint product may be prevented from leaking through the coupling and may only exit the nozzle assembly 108 through the at least one spray tip orifice 604. As discussed above, the at least one spray tip orifice 604 may result in the spray pattern in a desired shape specific to a particular spray tip 504, according to some embodiments. For example the user may remove a first spray tip and exchange it with a second spray tip that produces a different liquid paint product spray profile. For example, the first spray tip may be configured to spray liquid paint product in a circular pattern, a second spray tip may be configured to spray liquid paint product in a half circle pattern, and a third spray tip may be configured to spray liquid paint product in a crescent moon pattern. It will be understood by those skilled in the art that many different spray patterns may be created and remain within the scope of the present invention.

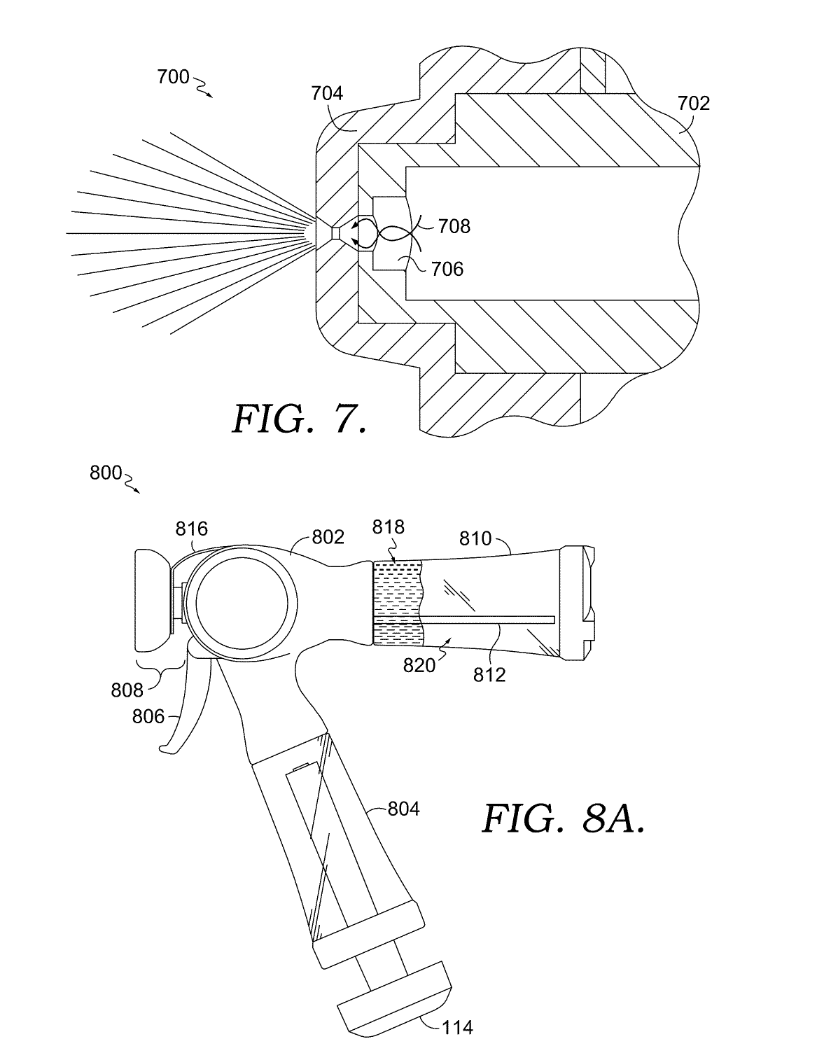

Turning now to FIG. 7, an enlarged cross-sectional portion of a simplified nozzle assembly 700 includes a dispersion nozzle 702, a spray tip 704, and a vortex chamber 706. The dispersion nozzle 702, the spray tip 704, and the vortex chamber 706 of the exemplary nozzle assembly 700 of FIG. 7 are arranged along a central x-axis. Embodiments of the invention include a vortex chamber 706 being defined by a hollow cavity created between the dispersion nozzle 702 the spray tip 704. Liquid paint product entering the vortex chamber 706 from the dispersion nozzle 702 may create, at least partially, a vortex 708 which may, at least partially, atomize a portion of the liquid paint product in the vortex chamber 706. It will be understood by those skilled in the art that FIG. 7 is a simplified representation of FIG. 6 to emphasize the vortex chamber 706 and the vortex 708 and not meant as a limitation on the disclosed invention.

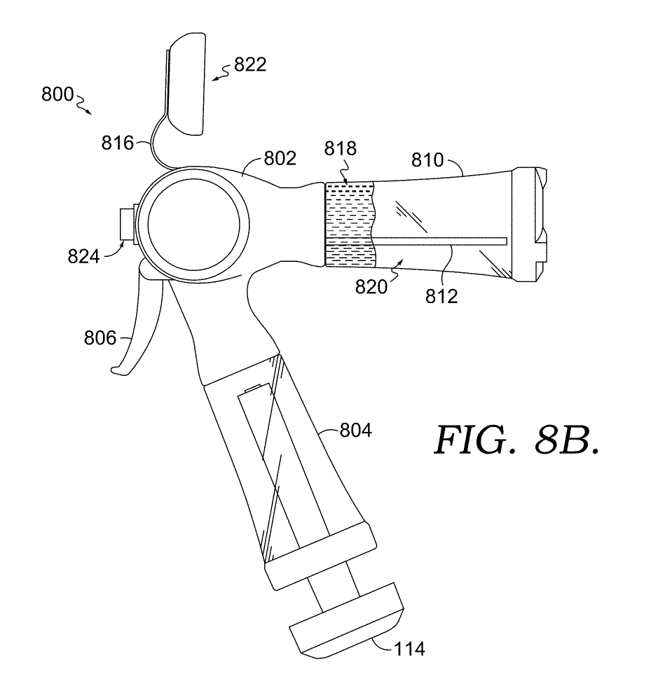

Turning now to FIG. 8A, an exemplary embodiment of the outdoor paint sprayer device 800 includes: a nozzle assembly 810 coupled to a first position of the sprayer body 810; a tip harness 816 coupled to the nozzle assembly 810 and to a second position of the sprayer body 810; a paint chamber 810, with a proximal first end and a distal second end opposite the proximal first end, wherein the proximal first end of the paint chamber 810 is coupled at a third position of the sprayer body 810; an air hose 812 for delivery of air proximate the distal second end of the paint chamber 810, an air pump chamber 804 coupled to a fourth position of the sprayer body 810, and a trigger mechanism 806 for activating the sprayer device 800. In other words, the sprayer device 800 may comprise a sprayer body 802 with multiple coupling locations. As an example, a nozzle assembly 810 may be coupled to the sprayer body 802 at a first location of the sprayer body 802 coupling locations. As another example, a tip harness may be coupled to the sprayer body 802 at a second location of the sprayer body 802 coupling locations. As another example, a paint chamber 810 may be coupled to the sprayer body 802 at a third location of the sprayer body 802 coupling locations. As a further example, an air pump chamber 804 may be coupled to the sprayer body at a fourth location of the sprayer body 802 coupling locations. Those skilled in the art will recognize that the preceding examples represent merely a small subset of the possible configurations consistent with the scope of the claimed invention and many other configurations are possible within the scope of the claimed invention.

Further, FIG. 8A includes a depiction of a liquid paint product 818 and a pressurized air pocket 820 within the paint chamber 810. As depicted, in an embodiment, air delivered through the air hose 812 proximate the distal second end of the paint chamber 810 may, at least partially, create a pressurized air pocket 820 which may force, at least, a portion of the liquid paint product 818 to the proximal first end of the paint chamber 810.

Turning now to FIG. 8B, an exemplary embodiment of the outdoor paint sprayer device 800 with the nozzle assembly is depicted in an at least partially disassembled view. As discussed above, in embodiments, the spray tip 822 may be removably coupled to the dispersion nozzle 824. In embodiments, the tip harness 816 is removably coupled at a first end to the spray tip 822 and coupled to the spray body 802 at a second end of the tip harness 816. As such, the nozzle assembly may be at least partially disassembled to facilitate cleaning of the spray tip 822 and the dispersion nozzle 824.

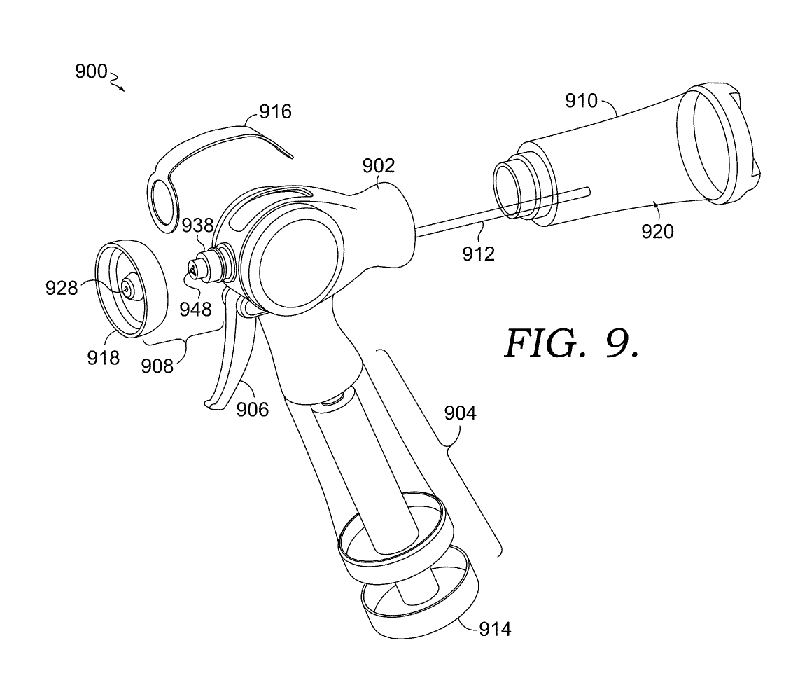

Turning now to FIG. 9, a partially exploded exemplary outdoor paint sprayer device 900 includes a sprayer body 902, an air pump chamber 904, a trigger mechanism 906, a nozzle assembly 908, a tip harness 916, a paint chamber 910, and an air hose 912 oriented around a central sprayer body 902. In embodiments, the nozzle assembly 908 further comprises a spray tip 918 with at least one spray orifice 928 and a dispersion nozzle 938 with a plurality of dispersion nozzle orifices 948. As depicted, in embodiments the spray tip 918 may be removably coupled to the dispersion nozzle 938. In a further embodiment, the tip harness 916 is removably coupled at a first end to the spray tip 918 and coupled to the spray body 902 at a second end.

In embodiments, the paint chamber 910 may be removably coupled to the sprayer body 902 at the proximal first end of the paint chamber 910. As such, the paint chamber 910 may comprise refill reservoir 920 for holding liquid paint product, wherein the refill reservoir 920 is a hollow cavity defined by the paint chamber 910. As depicted the paint chamber may be removed to allow a user to clean the paint chamber 910, the refill reservoir 920, or the air hose 912, refill the refill reservoir 920 with similar liquid paint product, or fill the refill reservoir 920 with a different liquid paint product, for example a liquid paint product of the different color. In an embodiment the outdoor paint sprayer further comprises a paint chamber cap (not depicted) that may be removably coupled to the proximal first end of the paint chamber 910 when the paint chamber 910 is removed from the sprayer body 902. As such, the paint chamber 910 may be sealed by the paint chamber cap to prevent spilling of the liquid paint product, temporary or long term storage of the liquid paint product, and/or prevent unwanted evaporation, drying, or curing of the liquid paint product.

For example, a user may fill the refill reservoir 920 of the paint chamber 910 with a desired liquid paint product, for example a green liquid paint; the user may then couple the paint chamber 910 to the sprayer body 902; the user may then, as discussed above in reference to other figures, repeatedly pump the air pump mechanism by alternating pulls and pushes on the pump handle 914, such that air is forced into the air pump chamber 904; air may then flow from the air pump chamber 904 through, at least, the air hose 912, such that the paint chamber may become pressurized; the user may stop pumping air into the air pump chamber 904 when the desired pressure is reached and may activate the trigger mechanism 906; the trigger mechanism 906 may open a valve assembly and the air pressure may force, at least, a portion of liquid paint product through at least one paint hose and valve assembly to the dispersion nozzle 938. The dispersion nozzle 938 may channel, at least, a portion of the liquid paint product into the plurality of dispersion orifices 948. A portion of liquid paint product may then form a vortex which may result is at least a portion of the liquid paint product to atomize, upon exiting the plurality of dispersion orifices 948. The atomized liquid paint product may then pass through the spray tip 918 and a spray of atomized liquid paint product may exit the outdoor paint sprayer 900 through the at least one spray tip orifice 928. At some point, the user may stop activating the trigger mechanism 906 and wish to change liquid paint products, for example to change colors. The user may uncouple the paint chamber 910. Then the user may cap the paint chamber 910 with the paint chamber cap for later use. The user may then fill the refill reservoir of a second paint chamber, similar to the paint chamber 910, with a second liquid paint product, for example a red liquid paint. The user may then couple the second paint chamber to the spray body 902 and repeat the process as many times as desired. It will be understood by those skilled in the art that the preceding example uses are not intended to be limiting and merely one, of many, possible examples of how one embodiment, of many possible embodiments, of the disclosed invention can be used.

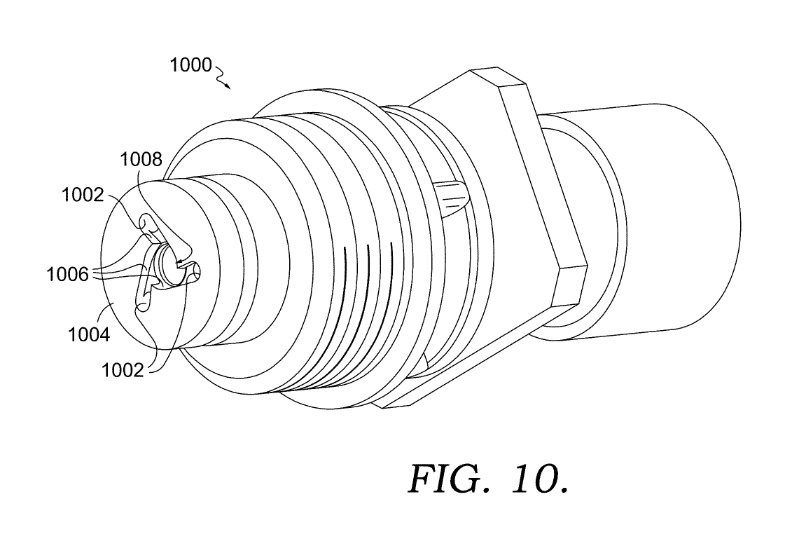

Turning to FIG. 10, a perspective view of an exemplary dispersion nozzle 1000 is depicted. In embodiments, the plurality of dispersion orifices 1002 may be configured in a specific orientation around a central x-axis and a central y-axis. For example, in an embodiment, the plurality of dispersion orifices 1002 may be three dispersion orifices configured in a triangular orientation around a central x-axis and a central y-axis. As another example, in an alternative embodiment, the plurality of dispersion orifices 1002 may be six dispersion orifices configured in a triangular orientation around a central x-axis and a central y-axis. In other alternative embodiments, the plurality of dispersion orifices 1002 may be comprise any number of dispersion orifices, greater than one, configured in any orientation around a central x-axis and a central y-axis.

In embodiments, the dispersion nozzle 1000 may comprise a first surface 1004 and the plurality of dispersion orifices 1002 may be at least partially recessed from the forward surface 1004. In further embodiments, a recessed guide channel 1006 may connect the plurality of dispersion orifices 1002 to a predetermined location, for example a location centered about the central x-axis and y-axis. In embodiments, the guide channel 1006 may be configured such that, when a spray tip is coupled to the dispersion nozzle, liquid paint product is directed through the guide channel 1006 into the vortex chamber 1008. In such an embodiment the guide channel 1006 may, at least partially, aid in the atomization of at least a portion of the liquid paint product. For example, the guide channel 1006 may be configured such that at least a portion of liquid paint product flows in, at least, a partially circular path as the liquid paint product enters the vortex chamber 1008. This may aid in the formation of a vortex motion as described above. As another example, the guide channel 1006 may be configured such that at least a portion of liquid paint product flowing from a first of the plurality of dispersion orifices 1002 forcibly collides with, at least, a portion of liquid paint product flowing from, at least, a second of the plurality of dispersion orifices 1002. This forcible collision may aid in the atomization of at least a portion of the liquid paint product.

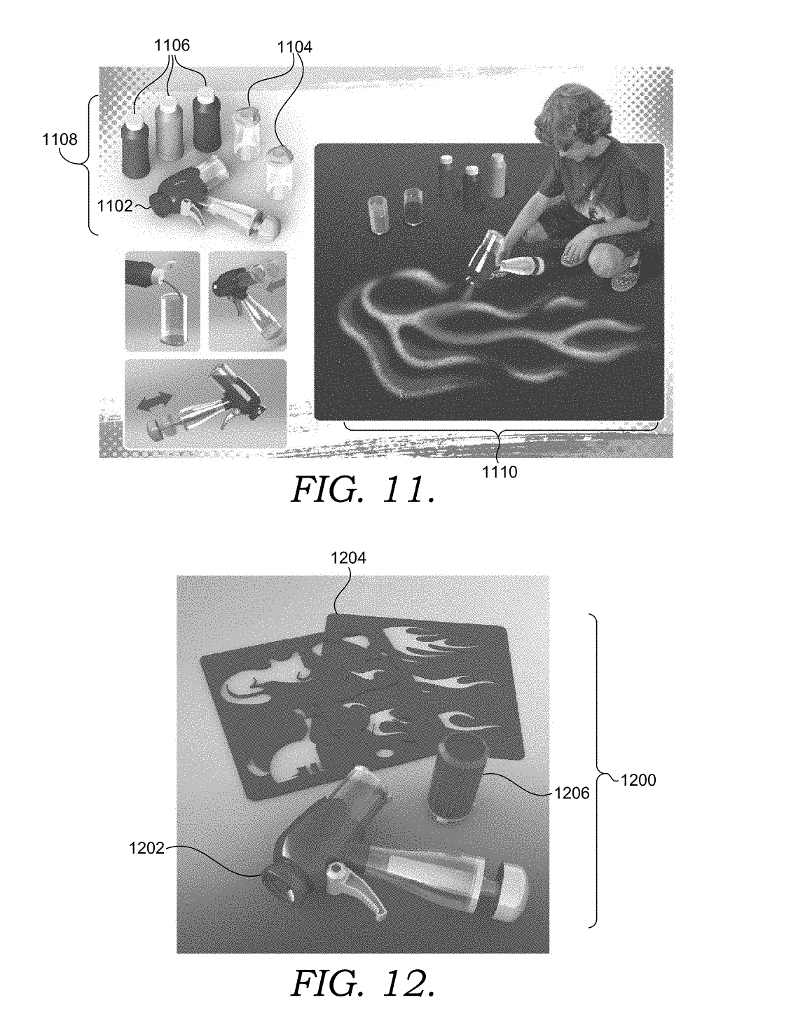

Turning now to FIG. 11, an exemplary outdoor paint sprayer kit 1108 is depicted in an exemplary use case. In embodiments, the outdoor paint sprayer kit 1108 may comprise an outdoor paint sprayer 1102, a plurality of liquid paint products 1106, and a plurality of paint chambers with paint chamber caps 1104. As depicted, the outdoor paint sprayer 1102 may be used to spray paint onto a suitable surface 1110.

Turning now to FIG. 12, a second exemplary outdoor paint sprayer kit 1200 is depicted. In embodiments the second outdoor paint sprayer kit may comprise an outdoor paint sprayer 1202, one or more stencils 1204, and at least one paint chamber with paint chamber cap 1206. In embodiments, the one or more stencils 1204 may be in any design suitable to allow liquid paint product to be sprayed by the outdoor paint sprayer 1202 such that liquid paint product is applied to a suitable surface in the design of the particular stencil.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. An outdoor paint sprayer device comprising:
a nozzle assembly comprising a spray tip and a dispersion nozzle for dispersing an atomized paint from a liquid paint product, wherein the dispersion nozzle comprises a plurality of orifices;
a sprayer body coupled to the dispersion nozzle, at a first position of the sprayer body,
the sprayer body comprising a paint hose structure for providing the liquid paint product to the sprayer body, wherein the dispersion nozzle receives the liquid paint product from the paint hose structure.

2. The device of claim 1 further comprising:
a paint chamber coupled to the sprayer body, at a second position of the sprayer body, wherein the paint chamber provides the liquid paint product to the paint hose structure;

3. The device of claim 2 wherein the paint chamber is removably coupled to the sprayer body.

4. The device of claim 2, wherein the paint chamber comprises:
a proximal first end of the paint chamber, wherein the proximal first end of the paint chamber is coupled to the sprayer body;
a distal second end of the paint chamber opposite the proximal first end; and
a one-way air valve wherein the one-way air valve is configured to transfer air flowing into the paint chamber.

5. The device of claim 4, wherein the paint chamber further comprises:
a first air hose structure coupled to the one-way air valve,
wherein the air transferred by the one-way valve flows through the first air hose structure, and
wherein the air exits the first air hose structure proximate the distal second end of the paint chamber.

6. The device of claim 1, further comprising:
an air pump chamber coupled to the sprayer body, at a third position of the sprayer body;
a second air hose structure coupled between the air pump chamber and the one-way valve, said second air hose structure configured to provide air flowing from the air pump chamber to the one-way air valve;
wherein the air pump chamber comprises an air pump device, a pressure relief valve, and an air chamber.

7. The device of claim 1, wherein the spray tip is removably coupled to the dispersion nozzle.

8. The device of claim 7, further comprising a tip harness coupled to the sprayer body at a fourth position, wherein the spray tip is further coupled to the tip harness.

9. The device of claim 1, wherein the atomized paint comprises an undiluted liquid paint product.

10. The outdoor paint sprayer of claim 9, wherein the nozzle assembly is configured to dispense an atomized liquid paint product in a particular dispersion pattern.

11. The device of claim 1, wherein the nozzle feature further comprises a vortex chamber between the spray tip and the dispersion nozzle, and
wherein the vortex chamber receives the liquid paint product from the plurality of orifices of the dispersion nozzle.

12. The device of claim 11, wherein the swirl chamber is configured such that at least a portion of the liquid paint product is set into a vortex motion.

13. An outdoor paint sprayer device comprising:
a sprayer body;
a paint chamber coupled to the sprayer body at a first position;
an air pump chamber coupled to the sprayer body at a second position different than the first position;
a nozzle assembly coupled to the sprayer body at a third position different that the first position and the second position, wherein the nozzle assembly comprises a spray tip removably coupled to a dispersion nozzle;
a trigger mechanism for providing an indication to dispense paint from the paint chamber;
an air hose structure coupled between the air pump chamber and the paint chamber; and
a paint hose structure coupled between the paint chamber and the nozzle,
wherein the air pump chamber comprises at least a first valve assembly, and the paint chamber comprises at least a second valve assembly.

14. The device of claim 13 wherein the dispersion nozzle comprises a plurality of orifices.

15. The device of claim 13 wherein the coupling of the spray tip and the dispersion nozzle comprises a vortex chamber,
wherein the vortex chamber is configured such that at least a portion of the liquid paint product is set into a vortex motion.

16. The device of claim 13, wherein the paint chamber comprises a proximal first end and a distal second end,
wherein the proximal first end of the paint chamber is removably coupled to the sprayer body,
wherein the air hose structure extends through the proximal first end of the paint chamber and terminates at the distal second end of the paint chamber such that air travelling through the air hose structure exits the air hose structure proximate the distal second end of the paint chamber.

17. A device for dispensing an undiluted liquid paint, said device comprising:
a sprayer body comprising at least one nozzle assembly and at least one valve assembly;
an air pump chamber coupled to the sprayer body, said air pump chamber comprising a pressure relief valve assembly, a pump mechanism, and a pump chamber port; and
a paint chamber coupled to the sprayer body, said paint chamber comprising a one-way air valve,
wherein the paint chamber is separate from the air pump chamber.

18. The paint spraying device of claim 17, wherein the at least one nozzle assembly comprises:
a spray tip and a dispersion nozzle, said spray tip removably coupled to said dispersion nozzle, said dispersion nozzle coupled to said sprayer body.

19. The paint spraying device of claim 17, wherein the pump chamber port further comprises:
a first air hose structure, wherein the first air hose structure is coupled with the one-way air valve of the paint chamber, and
wherein air traveling through the air hose structure exits the air hose structure into the paint chamber.

20. The paint spraying device of claim 19, wherein the paint chamber further comprises:
a proximal first end and a distal second end, wherein the proximal first end of the paint chamber is coupled to the sprayer body;
a second air hose structure, wherein the second air hose structure is coupled with the one way air valve opposite the first air hose structure,
wherein air traveling through second air hose structure exits the second air hose structure proximate the distal second end of the paint chamber.
